(19) United States
(12) Patent Application Publication
(10) Pub. No.: US 2025/0205610 A1
(43) Pub. Date: Jun. 26, 2025

(54) Mobile Phone Gaming Grip Cover with Top-Mounted Charging Port

(71) Applicant: Michael Kidakarn, Manhattan Beach, CA (US)

(72) Inventor: Michael Kidakarn, Manhattan Beach, CA (US)

(21) Appl. No.: 18/393,845

(22) Filed: Dec. 22, 2023

(51) Int. Cl. A63F 13/92

(52) U.S. Cl. CPC A63F 13/92

(57) ABSTRACT

The present invention discloses a mobile phone gaming grip cover with top-mounted charging port, wherein the grip cover is designed to ensure a comfortable and ergonomic gaming experience, reducing the risk of carpal tunnel syndrome and fatigue. The invention discloses a plastic grip cover designed specifically for mobile gaming. The said cover relocates the recharging cable and charge port to the top part of the device, eliminating interference with the gamer's hands during horizontal phone holding. Further, the said invention comprises a magnetic wireless recharge function ring that enables power transfer without the need for a physical wire connection to the phone's recharge port.

### TECHNICAL FIELD

The present invention relates generally to mobile phone games, and more specifically, it relates to a mobile phone gaming grip cover with top-mounted charging port, wherein the grip cover is designed to ensure a comfortable and ergonomic gaming experience, reducing the risk of carpal tunnel syndrome and fatigue.

### BACKGROUND ART

Mobile phones and handheld devices are in widespread use. The devices are often expensive, leading users to purchase protective phone cases or grips to prevent damage to the phones due to dropping. It can be difficult for users to maintain their grip on the phone during activities such as texting, browsing, and taking pictures or selfies. Furthermore, phones and the phone screens can be utilized in different orientations, depending on the desired use and the preferences of the user.

Mobile games are becoming seamlessly incorporated into the day-to-day activities of people across diverse cultures and contexts. By 2013 the games industry is estimated to be worth $70 billion globally (PWC 2013), with the rise of smartphones, pads and tablets, mobile games and playful apps comprising the fastest-growing market share, estimated to reach over $9 billion in 2013 (Johnston 2013), with some predicting that the mobile device will become the ‘primary screen’ for games by 2016 (Peterson 2013).

As such playfulness pervades the everyday mobile media practices of millions of people around the world—many who would not, importantly, consider themselves ‘gamers’—it is clear that distinctions between types of gamers (e.g. ‘casual’ and ‘hardcore’) and their corresponding modes of gameplay are no longer adequate to the task of understanding and interpreting contemporary experience.

The US patent application that was published as US20230218071A1 in July 2023 discloses a phone grip attachment that includes a base configured for attachment to a phone and a finger-hold attached to the base. The finger-hold has a top member and a bottom member. The finger-hold is movable between an extended position in which an opening is defined between the top member and the bottom member for use in gripping the phone and a collapsed position in which the top member is substantially flat against the bottom member. The finger-hold can be biased to the extended position. The finger-hold can be rotatably attached to the base.

However, this prior is different from the subject matter being proposed in the present invention.

Today, mobile phone gamers often experience discomfort and potential damage to their devices due to the protruding charging cable while gripping the phone horizontally with both hands. The cable, originating from the left or right side of the phone, interferes with the gamer's fingers, causing pain, potential damage to the charge port, and ergonomic issues leading to conditions such as carpal tunnel syndrome and fatigue.

There is therefore need for an improved mobile phone gaming grip cover

### OBJECT OF THE INVENTION

The main object of the present invention is to provide a mobile phone gaming grip cover that has a top-mounted charging port in which the grip cover is designed to ensure a comfortable and ergonomic gaming experience, reducing the risk of carpal tunnel syndrome and fatigue.

The following summary is an explanation of some of the general inventive steps for the system, method, architecture and container in the description. The summary is not an extensive overview of the invention and does not intend to limit the scope beyond what is described and claimed.

The detailed description that follows and the drawings that are referred to in the detailed description will further describe the embodiments described in the summary as well as other embodiments. Accordingly, to understand all the embodiments described by this document, a full detailed description and drawings is needed.

### BRIEF DESCRIPTION OF THE DRAWING

The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 is a mobile phone as described in the present invention.

FIG. 2 is a mobile phone gaming grip cover with top-mounted charging port.

FIG. 3 is a grip cover with a cable and top-mounted wireless charging port.

### DESCRIPTION OF THE INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

Phone grips work wonders for those that have slippery hands which makes them very popular with people that want to use their phone while they are at the gym. Phone grips also work nicely when your fingers are cold (like in the winter), something that people using sockets always complain about.

Mobile devices have become ubiquitous in modern life. Whether at home, in a restaurant, in a gym, or elsewhere, it has become increasingly popular for individuals to view their mobile devices in an effort to stay connected and engaged. However, most mobile devices do not include their own stands, and thus need to be either propped up on another object or held in one's hand in order for the screen to be viewable in many circumstances and situations.

Additionally, an increasing number of mobile devices such as tablets, phones, and calculators now include the wireless charging capabilities, in which the mobile device may be positioned adjacent to a wireless charger to charge an internal battery using inductance. Such wireless chargers are commonly sold as round “pads” on which the mobile device may be positioned for wireless charging. However, the round nature of these pads often makes the positioning and orientation of the mobile device awkward when charging.

While support stands are widely available for propping up mobile devices (e.g., while eating), such support stands are typically of limited versatility. Thus, different support stands may be needed for different types of mobile devices owned by the same person. Additionally, the available orientations of such previous support stands are often limited. It would be hugely beneficial to use a support stand for a mobile device that is capable of supporting a wide range of different mobile devices, is adjustable into different orientations, and is capable of supporting a wireless charging pad so as to charge the mobile device as it is being supported.

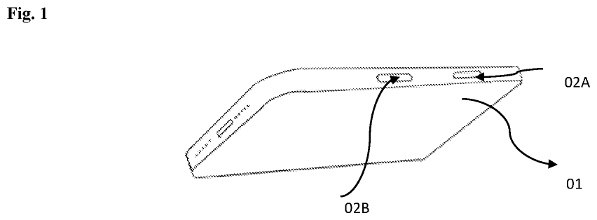

In a more general embodiment according to FIG. 1-FIG. 3, the present invention describes a mobile phone 01 gaming grip cover 04 with top-mounted charging port 06, wherein the grip cover 04 is designed to ensure a comfortable and ergonomic gaming experience, reducing the risk of carpal tunnel syndrome and fatigue.

More often than not, mobile phone gamers often experience discomfort and potential damage to their devices due to the protruding charging cable while gripping the phone horizontally with both hands. The cable, originating from the left or right side of the phone 01, interferes with the gamer's fingers, causing pain, potential damage to the charge port 06, and ergonomic issues leading to conditions such as carpal tunnel syndrome and fatigue.

### Solution

To address these issues, we propose an inventive solution—a plastic grip cover 04 designed specifically for mobile gaming. This cover relocates the recharging cable and charge port 06 to the top part of the device, eliminating interference with the gamer's hands during horizontal phone holding. Additionally, our solution incorporates a magnetic wireless recharge function ring that enables power transfer without the need for a physical wire connection to the phone's recharge port 06.

In FIG. 1, the invention describes a mobile phone 01 comprising a phone shutter 02 in adjustment to the phone starter 03.

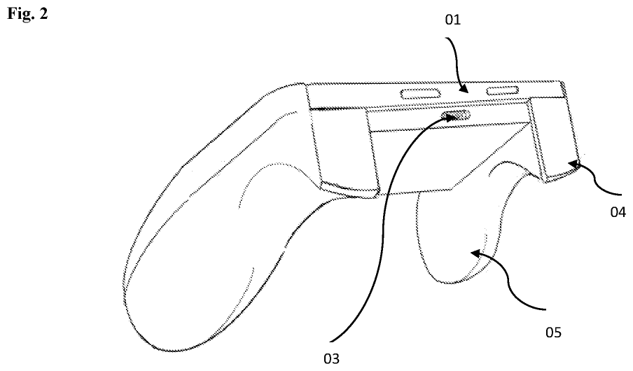

In FIG. 2, the invention describes a mobile phone 01 inserted in between a pair of gaming gripping cover 04 with top-mounted charging port 03 and a stand 05.

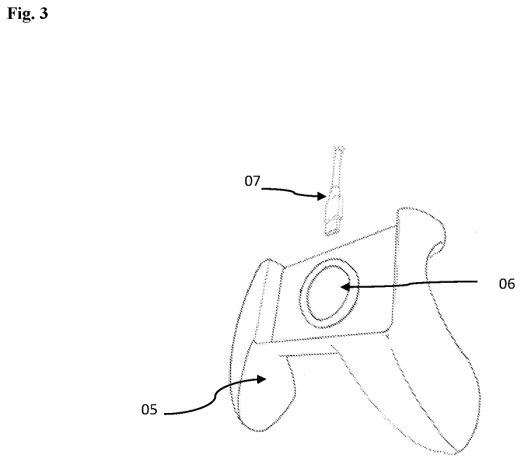

In FIG. 3, the invention discloses a grip cover 04 with a cable 07, top-mounted wireless charging port 06 and a stand 05.

### Advantages

Ergonomic Design: The grip cover 04 ensures a comfortable and ergonomic gaming experience, reducing the risk of carpal tunnel syndrome and fatigue.

Damage Prevention: By relocating the charging cable 07, the invention prevents potential damage to the phone's charge port 06 caused by movement during gameplay.

Pain Reduction: Eliminates the discomfort and pain caused by the protruding cable between the gamer's fingers, enhancing the overall gaming experience.

Wireless Charging: The incorporation of a magnetic wireless recharge 06 function ring provides a convenient and wire-free power transfer option for users.

This innovative solution not only addresses the current problems faced by mobile gamers but also enhances the overall usability and longevity of mobile gaming devices.

In the market there are magnetic rectangular battery packs that wirelessly attach to phones, the present invention has two handle grips shaped device (not rectangular) that wirelessly attaches to phones.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

This description outlines the fundamental aspects of the invention. Additional technical details, specifications, and embodiments will be provided in the detailed description section of the patent application. While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments. Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention relates applies to mobile phone games. The invention provides a mobile phone gaming grip cover with top-mounted charging port. The grip cover is designed to ensure a comfortable and ergonomic gaming experience, reducing the risk of carpal tunnel syndrome and fatigue. In the market there are magnetic rectangular battery packs that wirelessly attach to phones, the present invention has two handle grips shaped device (not rectangular) that wirelessly attaches to phones.

What is claimed is:

1. A mobile phone gaming grip cover, comprising:
a plastic grip cover;
a top-mounted charging port, and
a magnetic wireless recharge function ring.

2. The mobile phone gaming grip cover as in claim 1, wherein the plastic grip cover is designed specifically for mobile gaming.

3. The mobile phone gaming grip cover as in claim 1, wherein the top-mounted charging port is connected to cable for charging the phone while in use.

4. The mobile phone gaming grip cover as in claim 2, wherein the cover relocates the recharging cable and charge port to the top part of the device, eliminating interference with the gamer's hands during horizontal phone holding.

5. The mobile phone gaming grip cover as in claim 1, wherein the magnetic wireless recharge function ring is designed to enable power transfer without the need for a physical wire connection to the phone's recharge port.

6. The mobile phone gaming grip cover as in claim 1, wherein the said cover further comprises an ergonomic design that enables the grip cover to ensure a comfortable and ergonomic gaming experience, reducing the risk of carpal tunnel syndrome and fatigue.

7. The mobile phone gaming grip cover as in claim 6, wherein the said cover ensures damage prevention by relocating the charging cable by preventing potential damage to the phone's charge port caused by movement during gameplay.

8. The mobile phone gaming grip cover as in claim 7, wherein the said cover is designed to reduce pain by eliminating the discomfort and pain caused by the protruding cable between the gamer's fingers, enhancing the overall gaming experience.

9. The mobile phone gaming grip cover as in claim 5, wherein the said cover further comprises a magnetic wireless recharge function ring that is designed to provide a convenient and wire-free power transfer option for users.

10. The mobile phone gaming grip cover as in claim 5, wherein the said cover is designed to enhance the overall usability and longevity of mobile gaming devices.

11. The mobile phone gaming grip cover as in claim 9, wherein the said cover has two handle grips shaped device that wirelessly attaches to phones.
